(19) United States
(12) Patent Application Publication
(10) Pub. No.: US 2014/0094171 A1
(43) Pub. Date: Apr. 3, 2014

(54) WIRELESS COMMUNICATION METHOD, TRACKING ERROR MANAGEMENT DEVICE, AND MOBILITY MANAGEMENT DEVICE

(71) Applicant: HITACHI, LTD., Tokyo (JP)

(72) Inventors: Ryouichi TANAKA, Tokyo (JP); Koji WAKAYAMA, Tokyo (JP); Tsuyoshi KAJITA, Tokyo (JP); Yusuke SHOMURA, Tokyo (JP)

(73) Assignee: HITACHI, LTD., Tokyo (JP)

(21) Appl. No.: 14/040,873

(22) Filed: Sep. 30, 2013

(30) Foreign Application Priority Data
Oct. 1, 2012 (JP) 2012-219030

(51) Int. Cl. H04W 64/00

(52) U.S. Cl. CPC H04W 64/00
USPC 455/435.1

(57) ABSTRACT

A paging signal is transmitted to plural base stations which are prioritized with the use of communication results between a wireless communication terminal and the base stations to provide means for suppressing a control signal traffic, and a bandwidth used for a control signal can be effectively used.

### CLAIM OF PRIORITY

The present application claims priority from Japanese patent application JP 2012-219030 filed on Oct. 1, 2012, the content of which is hereby incorporated by reference into this application.

### TECHNICAL FIELD

The present invention relates to a system that controls transmission of a paging signal, and a method thereof in a wireless communication system having a tracking area configured with plural base stations.

### BACKGROUND

In a wireless communication system for mobile objects, a position of a wireless communication terminal in a standby state is managed on a tracking area basis. The tracking area is configured with one or plural wireless base stations.

Each of the wireless base stations is informed of an identifier of the tracking area to which a station in question belongs. The wireless communication terminal in the standby state conducts a position registration in an HSS with respect to the tracking area in which the station in question is present. The wireless communication terminal stores the identifier of the tracking area that has been currently positionally registered, receives the identifier of the informed tracking area in association with the travel of the wireless communication terminal, and confirms whether there is a change in the tracking area, or not. For example, the wireless communication terminal travels to an adjacent wireless base station, and if the identifier of the tracking area notified from the adjacent wireless base station is different from the identifier of the tracking area currently registered, the wireless communication terminal updates the position registration.

If a reception is conducted by the wireless communication terminal, the wireless communication system for mobile objects pages all of the wireless base stations configuring the tracking area in which the wireless communication terminal in question has been positionally registered. The wireless communication terminal has been called up by paging, the wireless communication terminal accesses to the wireless base station in which the wireless communication terminal is present, and establishes a connection.

### SUMMARY

Because a paging signal is transmitted to all of the wireless base stations belonging to the tracking area, the paging signal is transmitted to cells in which the wireless communication terminal to be called up is absent. For that reason, when the number of wireless base stations configuring the tracking area is too large, there arises such a problem that a bandwidth used for a control signal gets vainly employed. In order to reduce an overhead of the paging, there is a need to transmit the paging signal to the wireless base station in which the wireless communication terminal in question is present as much as possible.

In Japanese Unexamined Patent Application Publication (Translation of PCT Application) No. Hei-10 (1998)-502229, the paging signal is transmitted from the wireless base stations in an ascending order of a traffic volume to reduce the traffic of the control signals. However, prioritization is not conducted from the viewpoint of whether the wireless communication terminal to be called up is present, or not, as a result of which an unnecessary paging signal is generated.

Also, in Japanese Unexamined Patent Application Publication (Translation of PCT Application) No. 2001-520816, a unique unit such as MSU is arranged, and the terminal accesses to the MSU for management of position information, to enable the terminal position to be specified. However, because a format of a signal for allowing the MSU to specify the terminal position, and an interface thereof are not present in a standard, a system operation of a standard compliance is not conducted. Therefore, the MSU lacks general versatility.

Under the circumstances, the present invention aims at providing a system and a method, which enable the system operation of the standard compliance, estimates an existing position of a wireless communication terminal, prioritizes the wireless base stations to transmit a paging signal to the wireless base stations, and enables the suppression of a control signal traffic.

An outline of a typical feature of the invention disclosed in the present application will be described in brief below.

There is provided a wireless communication method in a wireless communication system that transmits a paging signal to plural base stations configuring a tracking area, including: allowing a wireless communication terminal to communicate with each of plural base stations; generating information on a position of the wireless communication terminal on the basis of communication results between the wireless communication terminal and each of the plural base stations; determining a prioritization of the plural base stations to which the paging signal is transmitted on the basis of the information on the position of the wireless communication terminal; and transmitting the paging signal to the base stations on the basis of the prioritization.

According to the present invention, an unnecessary paging signal can be reduced, and the control signal traffic can be suppressed.

Problems, configurations, and advantages other than those described above will become apparent from a description of the following embodiments.

### BRIEF DESCRIPTION OF THE DRAWINGS

FIG. 1 is an exemplary diagram illustrating an overall configuration of a system according to a first embodiment;

FIG. 2 is an exemplary diagram illustrating a detailed configuration of the system according to the first embodiment;

FIG. 3 is an exemplary diagram illustrating a configuration of a wireless base station;

FIG. 4 is an exemplary diagram illustrating a configuration of a femto base station;

FIG. 5 is an exemplary diagram illustrating a configuration of a femto base station;

FIG. 6 illustrates an example of a tracking area database;

FIG. 7 is an exemplary diagram illustrating a configuration of a tracking area management device according to the first embodiment;

FIG. 8 illustrates an example of a wireless base station information database according to the first embodiment;

FIG. 9 illustrates an example of a wireless communication terminal information database according to the first embodiment;

FIG. 10 is an exemplary flowchart of prioritization of the wireless base stations according to the first embodiment;

FIG. 11 illustrates an example of a wireless base station prioritization table according to the first embodiment;

FIG. 12 is an exemplary flowchart of paging signal transmission according to the first embodiment;

FIG. 13 is an exemplary diagram illustrating an overall configuration of a system according to a second embodiment;

FIG. 14 is an exemplary diagram illustrating a detailed configuration of the system according to the second embodiment;

FIG. 15 is an exemplary diagram illustrating a configuration of an MME according to the second embodiment;

FIG. 16 illustrates an example of a wireless base station information database according to a third embodiment;

FIG. 17 is an exemplary flowchart of prioritization of the wireless base stations according to the third embodiment; and

FIG. 18 illustrates an example of a wireless base station prioritization table according to the third embodiment.

### DETAILED DESCRIPTION

### First Embodiment

Hereinafter, embodiments of the present invention will be described in detail with reference to the accompanying drawings.

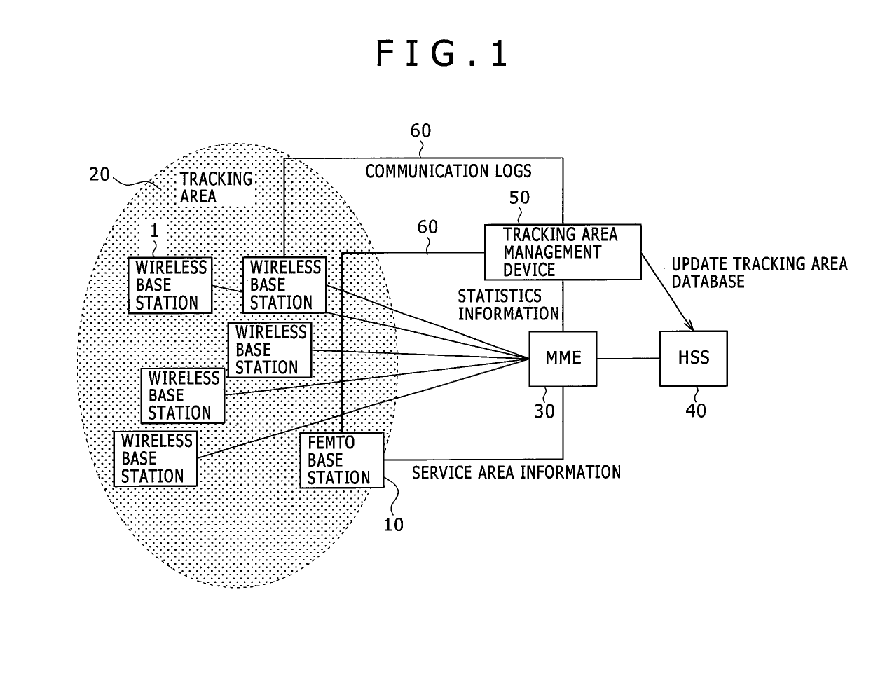

FIG. 1 is a configuration diagram of a wireless communication system according to a first embodiment. In a wireless communication system in which a tracking area 20 including plural wireless base stations 1 and a femto base station 10 is present, a mobility management device (MME) 30 that manages the wireless base stations 1 and the femto base station 10 is located. In calling up a wireless communication terminal, the MME 30 transmits a paging signal to the wireless base stations 1 in the tracking area 20 in which the wireless communication terminal is present with reference to a tracking area database of a subscriber information management server (HSS) 40. Information of the tracking area database in the HSS 40 is regularly updated by a tracking area management device 50. The tracking area management device 50 collects statistics information about communications in the wireless base stations from the MME 30, collects a communication log for each wireless communication terminal from the wireless base stations 1, collects service area information on the femto base station from the femto base station 10, and updates the tracking area database in the HSS 40.

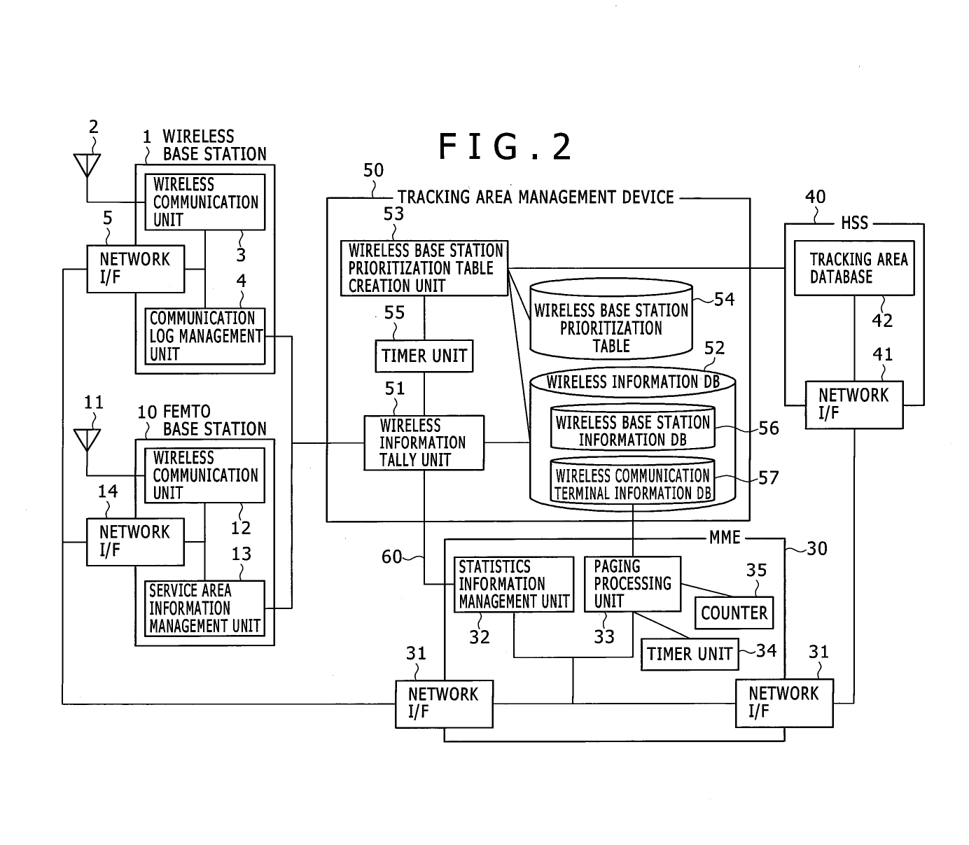

FIG. 2 is a diagram illustrating a detailed configuration of a management system according to the first embodiment. The wireless base stations 1 each include a wireless communication unit 3 that is connected to an antenna 2, a communication log management unit 4, and a network interface 5 that is connected to the MME 30. The wireless base station 1 communicates with the wireless communication terminal through the wireless communication unit 3 from the antenna 2, generates communication logs at the time of starting and ending a communication, and at the time of implementing a handover, and saves the communication logs in the communication log management unit 4. The communication logs including a call connection and a disconnection history for each wireless communication terminal are transmitted to a wireless information, which have been saved in the communication log management unit 4, are transmitted to a wireless information tally unit 51 in the tracking area management device 50 through a wired network 60.

Likewise, the femto base station 10 includes a wireless communication unit 12 that is connected to an antenna 11, a service area information management unit 13 that saves IDs of the wireless communication terminals that are present in a service area of the femto base station, and a network interface 14 that is connected to the MME 30. The femto base station 10 communicates with the wireless communication terminal through the wireless communication unit 12 from the antenna 11, and saves information on the terminal which is present in the femto base station 10 in question in the service area information management unit 13. The information on the terminal present in the service area, which has been saved in the service area information management unit 13, is transmitted to the wireless information tally unit 51 in the tracking area management device 50 through the wired network 60.

Also, the MME 30 collects statistics information including the number of calls for each of the wireless base stations, the number of handovers to an adjacent wireless base station, and the number of transmission of the paging signals through a network interface 31, and saves the statistics information in a statistics information management unit 32. The information collected in the statistics information management unit 32 is transmitted to the wireless information tally unit 51 in the tracking area management device 50 through the wired network 60.

The communication logs, the information on the terminal present in the service terminal, and the statistics information are used for determining the prioritization of the base stations to which the paging signal is to be transmitted as information on the position of the wireless communication terminal as will be described later. The wireless information tally unit 51 of the tracking area management device 50 which has received the information on the position of the wireless communication terminal updates a wireless information database 52. Also, a wireless base station prioritization table creation unit 53 of the tracking area management device 50 prioritizes the wireless base stations to which the paging signal is transmitted in each of the tracking areas according to the information of the wireless information database 52, and updates a wireless base station prioritization table 54. Upon updating the wireless base station prioritization table 54, the wireless base station prioritization table creation unit 53 updates base station prioritization items of a tracking area database 42 in the HSS 40. Also, the wireless base station prioritization table creation unit 53 can regularly conduct those processing with the use of a timer unit 55.

During a paging process, a paging processing unit 33 accesses to a wireless communication terminal information database 57, or accesses to the tracking area database 42 of the HSS 40 through the network interface 31, and determines the tracking area to which the paging signal is transmitted, and transmits the paging signal according to the prioritization within the tracking area database 42.

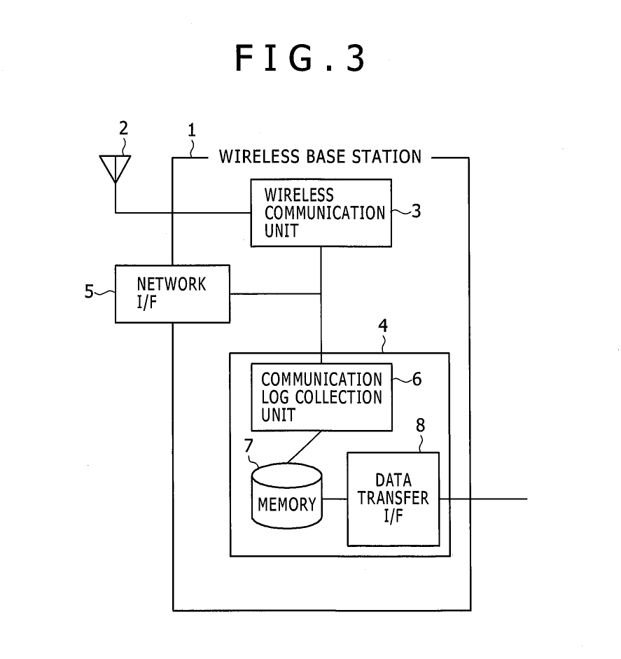

FIG. 3 is a configuration diagram of the wireless base stations 1 according to the first embodiment. The wireless base stations 1 includes the antenna 2 that conducts a wireless communication with the wireless communication terminal, the wireless communication unit 3 that processes a signal received from the antenna 2 or a transmit signal to the wireless communication terminal, the communication log management unit 4 that deals with the communication logs of the wireless communication terminal, and the network interface 5 for connection to the MME 30 or another network device.

The communication log management unit 4 includes a communication log collection unit 6 that collects the communication logs, a memory 7 that stores the communication logs collected by the communication log collection unit 6 therein, and a data transfer interface 8 that transfers data within the memory 7 to the tracking area management device 50.

The functions of the wireless communication unit 3 and the communication log collection unit 6 are realized by reading and executing a variety of programs recorded by a CPU not shown. Alternatively, those functions can be realized by a logic circuit.

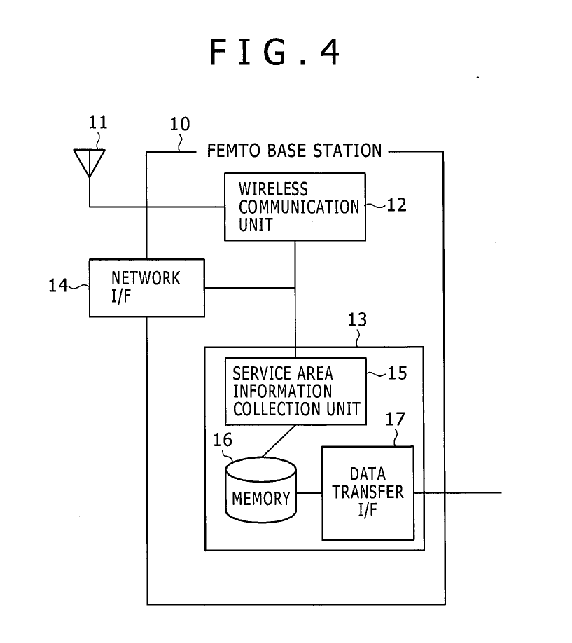

FIG. 4 is a configuration diagram of the femto base station 10 according to the first embodiment. The femto base station 10 includes the antenna 11 that conducts a wireless communication with the wireless communication terminal, the wireless communication unit 12 that processes a signal received from the antenna 11, or a transmit signal to the wireless communication terminal, the service area information management unit 13 that deals with the service area information of the femto base station, and the network interface 14 for connection to the MME 30 or another network device.

The service area information management unit 13 includes a service area information collection unit 15 that collects wireless communication terminal IDs that are present within the service area of the femto base station, a memory 16 that stores the service area information collected by the service area information collection unit 15 therein, and a data transfer interface 17 that transfers the data in the memory 16 to the tracking area management device 50.

The functions of the wireless communication unit 12 and the service area information collection unit 15 are realized by reading and executing a variety of programs recorded by a CPU not shown. Alternatively, those functions can be realized by a logic circuit.

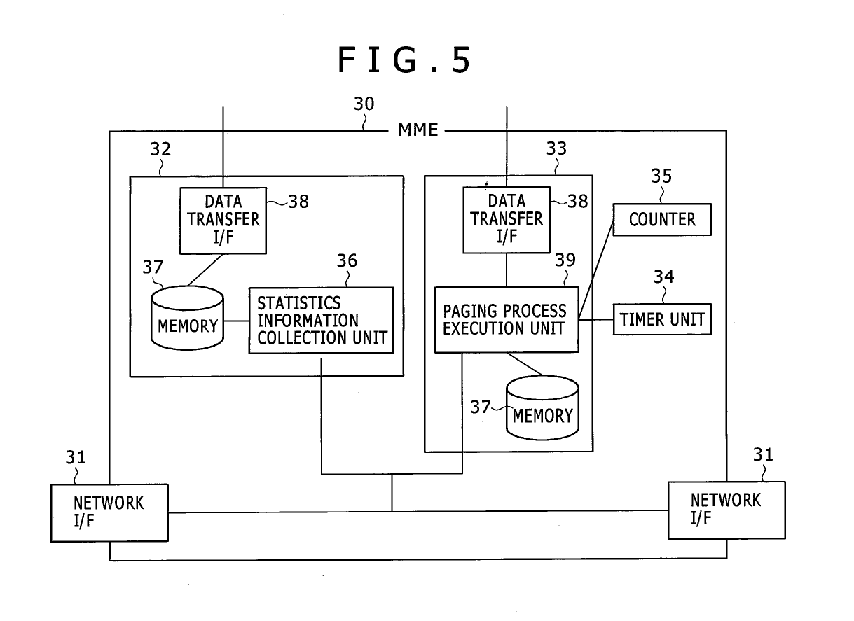

FIG. 5 is a configuration diagram of the MME 30 according to the first embodiment. The MME 30 includes the statistics information management unit 32 that collects statistics information which is collected from the network interface 31, the paging processing unit 33 that conducts the paging process on the basis of the information on the tracking area 20 obtained from the HSS 40 through the network interface 31, a timer unit 34 that measures a time required for the paging process, and a counter 35 that tallies the number of wireless base stations to which the paging signal has been transmitted.

The statistics information management unit 32 includes a statistics information collection unit 36 that collects the statistics information, a memory 37 that stores the statistics information collected by the statistics information collection unit 36, and a data transfer interface 38 that transfers the data in the memory 37 to the tracking area management device 50. Also, the paging processing unit 33 includes the data transfer interface 38 that collects the information from the wireless communication terminal information database 57 within the tracking area management device 50, the memory 37 that stores the information obtained from the wireless communication terminal information database 57, and threshold values of the number of transmission and a time required for the transmission in an algorithm at the time of transmitting the paging signal, and a paging process execution unit 39 that executes the paging process. The paging process execution unit 39 executes the paging process in conjunction with the timer unit 34 and the counter 35 within the MME 30.

The functions of the statistics information collection unit and the paging process execution unit 39 are realized by reading and executing a variety of programs recorded by a CPU not shown. Alternatively, those functions can be realized by a logic circuit.

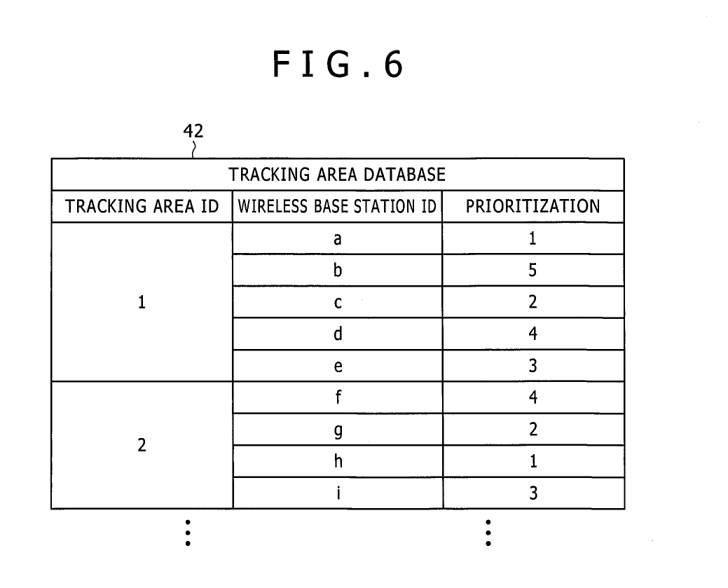

FIG. 6 illustrates an example of the tracking area database 42. The wireless base station IDs configuring the tracking area 20, and the prioritization of the wireless base station IDs to which the paging signal is to be transmitted are stored in the tracking area database 42 for each of the tracking area IDs.

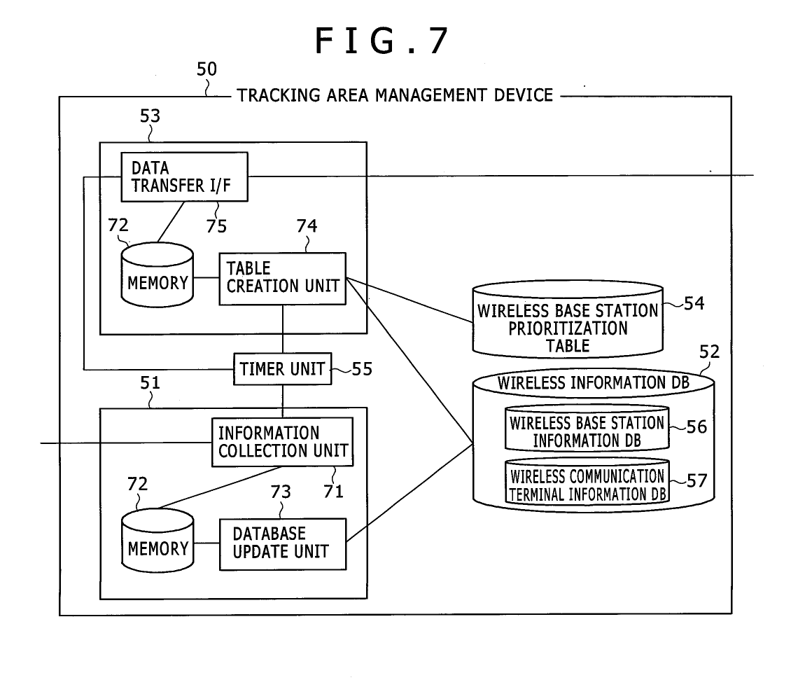

FIG. 7 is a configuration diagram of the tracking area management device 50 according to the first embodiment. The tracking area management device 50 includes the wireless information tally unit 51 that collects the information from the communication log management unit 4, the service area information management unit 13, and the statistics information management unit 32, and regularly updates the wireless information database 52, the wireless base station prioritization table creation unit that creates and updates the wireless base station prioritization table 54 with the use of the wireless information database 52, and the timer unit 55 that regularly operates the wireless information tally unit 51 and the wireless base station prioritization table creation unit 53.

Also, the wireless information database 52 includes a wireless base station information database 56 that stores the information for each of the wireless base stations, and the wireless communication terminal information database 57 that stores the information for each of the wireless communication terminals. The wireless information tally unit 51 includes information collection unit 71 that collects the respective information, a memory 72 that stores the information collected by the information collection unit 71, and a database update unit 73 that updates the database from the information stored in the memory 72. Also, the wireless base station prioritization table creation unit 53 includes the memory 72 that stores the information of the wireless information database 52 and the information of the prioritization table therein, a table creation unit 74 that creates a wireless base station prioritization management table on the basis of information stored in the wireless information database 52, and a data transfer interface 75 that transfers those data to the tracking area database 42.

The functions of the information collection unit 71, the database update unit 73, and the table creation unit 74 are realized by reading and executing a variety of programs recorded by a CPU not shown. Alternatively, those functions can be realized by a logic circuit.

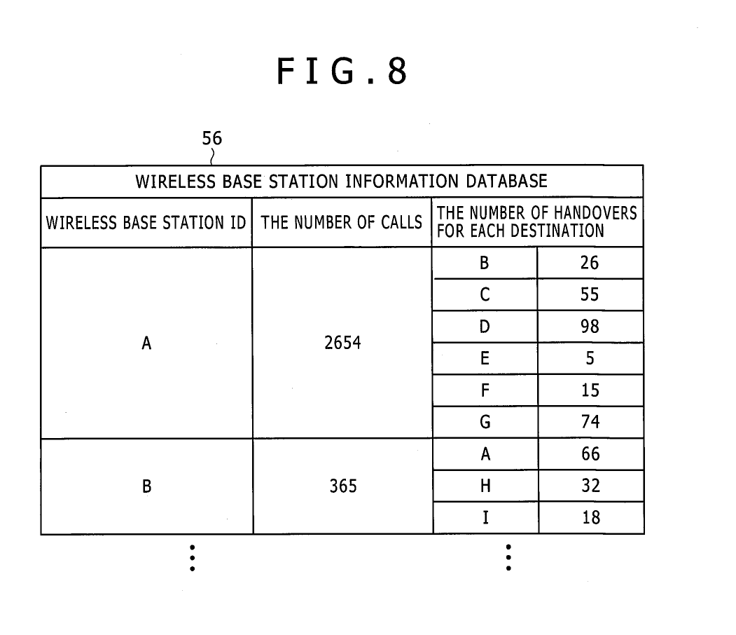

FIG. 8 illustrates an example of the wireless base station information database 56 according to the first embodiment. The number of calls generated in each of the wireless base stations within a given time, and the number of handovers for each of the destination wireless base station IDs are stored in the wireless base station information database 56 for each of the wireless base station IDs. FIG. 8 illustrates an example in which the number of handovers from the wireless base station whose wireless base station ID is A to the wireless base station whose wireless base station ID is B is 26. The information stored in the wireless base station information database is created on the basis of the statistics information received from the MME.

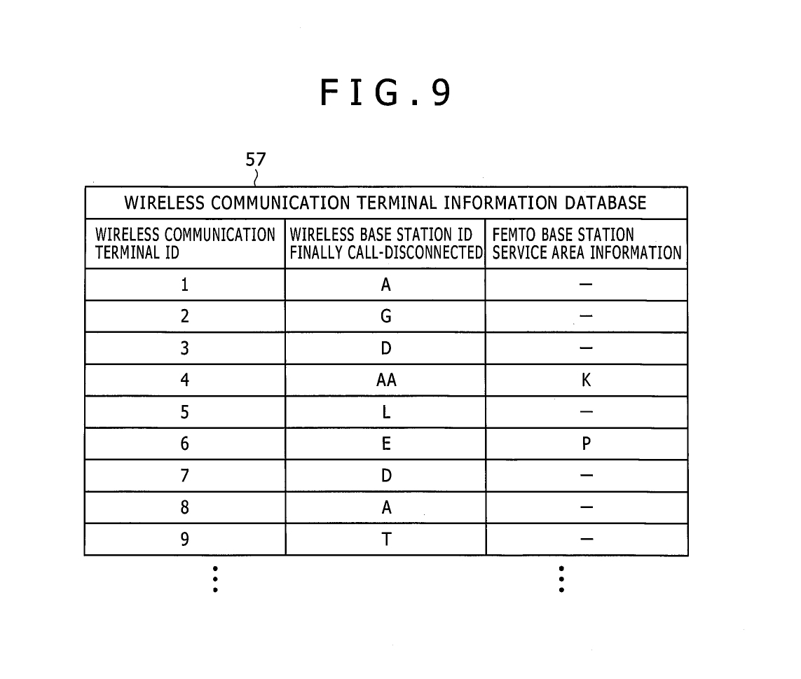

FIG. 9 illustrates an example of the wireless communication terminal information database 57 according to the first embodiment. The wireless base station ID whose call has been finally disconnected, and the service area information on the femto base station are stored in the wireless communication terminal information database 57 for each of the wireless communication terminal IDs. When the wireless base station is present in the service area of the femto base station, an ID of the femto base station of that service area is stored in the wireless communication terminal information database 57. The information stored in the wireless communication terminal information database is created on the basis of the communication logs received from the wireless base stations, and the information on the terminal present in the service area which is received from the femto base station.

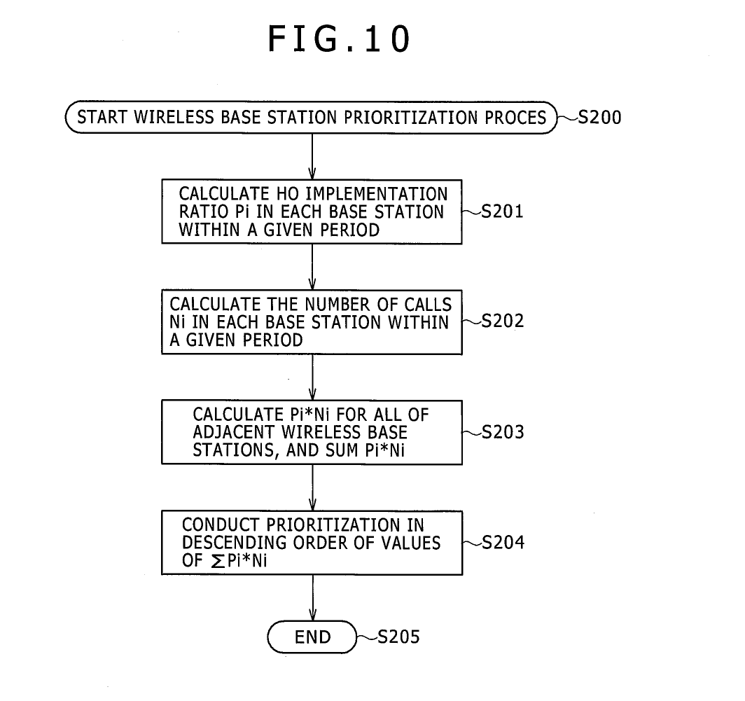

FIG. 10 is a flowchart of determining the prioritization of the wireless base stations within the tracking area according to the first embodiment. The prioritization is executed by the wireless base station prioritization table creation unit 53 with a given time elapsed in the timer unit 55 of the tracking area management device 50 as a trigger. In S200, wireless base station prioritization processing starts. First, in S201, a probability Pi of handover to a destination wireless base station is calculated according to the number of handovers to each destination in each of the wireless base stations within a given time in the wireless base station information database 56 within the wireless information database 52. Then, in S202, the number of calls Ni generated within a given time is calculated. In S203, Pi*Ni is calculated, and a summation thereof is calculated for all of the adjacent wireless base stations in each of the wireless base stations. That is, the probability of handover from the adjacent base stations for each of the wireless base stations is calculated. Finally, in S204, the prioritization is conducted in a descending order of values of ΣPi*Ni, and in S205, the wireless base station prioritization processing is completed.

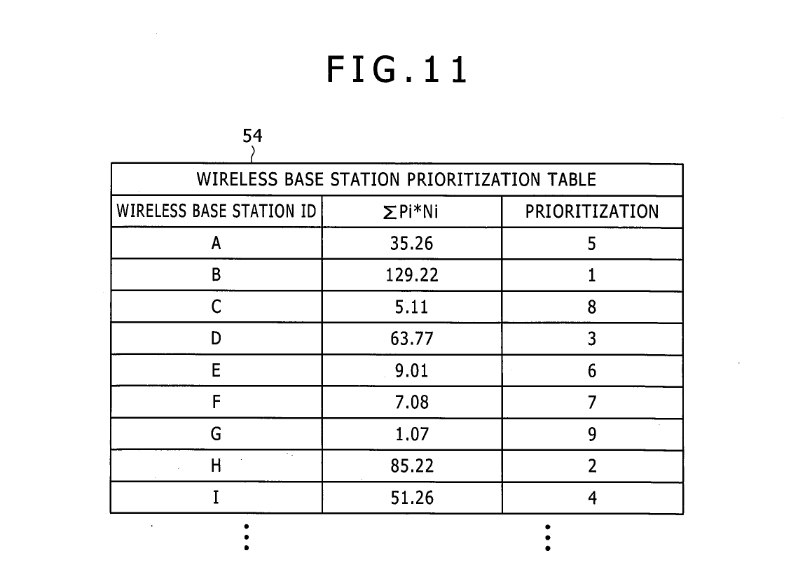

FIG. 11 illustrates an example of the wireless base station prioritization table 54 according to the first embodiment. The above-mentioned values of ΣPi*Ni and the prioritization of the paging signal transmission are stored for each of the wireless base station IDs in the wireless base station prioritization table 54.

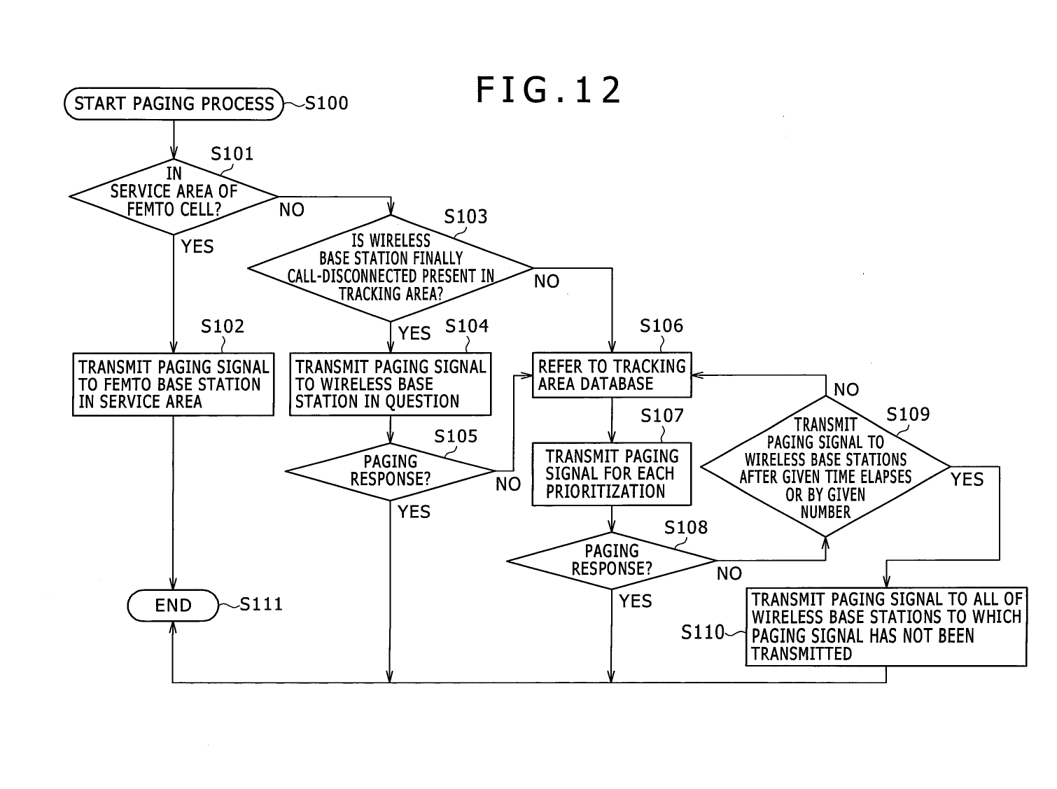

FIG. 12 is a flowchart of the paging process conducted by the paging processing unit 33 in the MME 30. In this flowchart, the paging signal is transmitted to the wireless base stations in a descending order of a probability that the wireless communication terminal from which the paging signal is to be called is present, to enable the paging signals to be reduced. As a result, a traffic of a control signal can be suppressed, and a load on the MME or the wireless base stations can be reduced. Also, in determining the base station high in the probability that the wireless communication terminal is present, that is, in determining the prioritization of transmission of the paging signal, the paging processing unit 33 refers to the wireless communication terminal information database 57 and the tracking area database 42. Because the wireless communication terminal information database 57 and the tracking area database 42 are generated on the basis of communication results between the wireless communication terminal and the wireless base stations, or communication results between the wireless communication terminal and the femto base station, a unique signal format or interface is not necessary, but the system operation of a standard compliance is enabled. Also, when there is no response even if the paging signal has been transmitted by a given number of times, or a given time has elapsed, the paging signal is transmitted over an overall tracking area as with a related-art paging signal, to thereby enable a time and the amount of signals required for the paging process to be equal to those of the existing technique at a maximum.

In S100, the paging process starts. First, in S101, it is determined whether the wireless communication terminal to be called is present in the service area of the femto base station, or not. If the wireless communication terminal is present in the service area of the femto base station, the paging signal is transmitted to the femto base station in the service area in S102, and the paging process is completed in S111. In S101, if the wireless communication terminal to be called is not present in the service area of the femto base station, it is determined from the communication logs, whether the wireless base station that has been finally call-disconnected by the wireless communication terminal to be called is present within the tracking area, or not. If the wireless base station that has been finally call-disconnected is present within the tracking area, the paging signal is transmitted to the wireless base stations in question in S104. If there is a paging response in S105, the paging process is completed in S111. If there is no paging response in S105, or if the wireless base station that has been finally call-disconnected by the wireless communication terminal to be called in S103 is not present within the tracking area, the tracking area database 42 in the HSS 40 is referred to in S106, and the paging signal is transmitted to the base stations in a descending order of the prioritization in S107. If there is the paging response in S108, the paging process is completed in S111. If there is no paging response in S108, and if the condition of S109 is not satisfied, the processing of S106 to S108 is repeated. If an elapsed time of the timer unit 34, that is, a given time is elapsed since the paging process starts, or if a value of the counter 35 exceeds a given value, that is, the paging signal is transmitted to a given number of wireless base stations in S109, the paging signal is transmitted to all of the wireless base stations to which the paging signal has not been transmitted in S110, and the paging process is completed in S111.

When the paging signal is transmitted in the flowchart illustrated in FIG. 12, the amount of control signal traffic can be reduced as compared with a case in which the paging signal is transmitted to all of the wireless base stations belonging to the tracking area up to now. Also, when a time limit or a limit of the number of transmissions is introduced in S109, the paging signal can be conducted temporally with the same required time and the same traffic volume as those in the related art

### Second Embodiment

Subsequently, a second embodiment of the present invention will be described in detail with reference to the drawings. In the second embodiment of the present invention, the function of the tracking area management device according to the first embodiment is provided with the MME. With the configuration of this embodiment, the same advantages as those in the first embodiment can be obtained without the installation of the tracking area management device separately from the other network management devices.

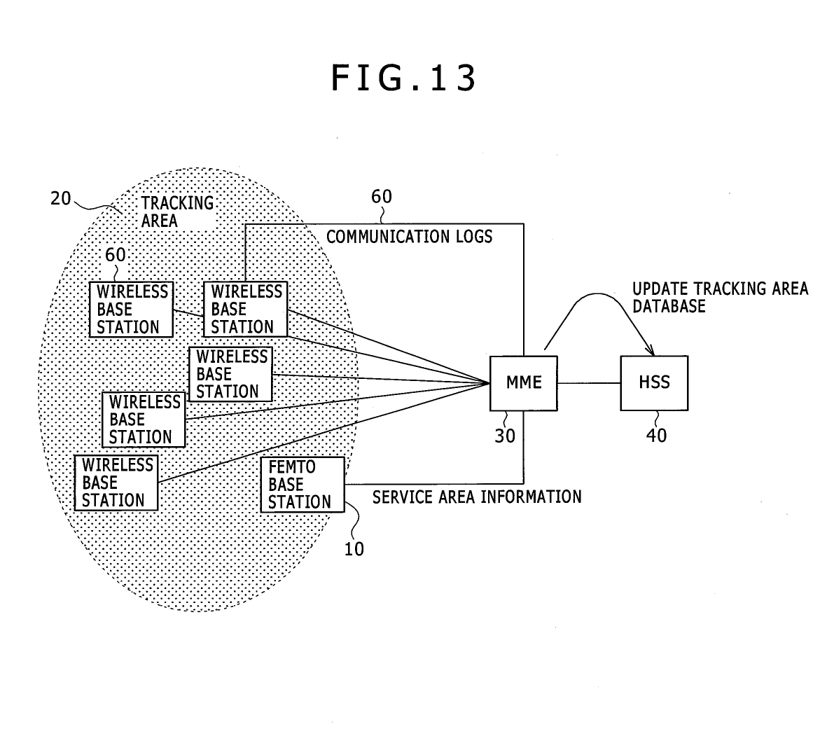

FIG. 13 is a configuration diagram illustrating a wireless communication system according to a second embodiment. In the wireless communication system in which the tracking area 20 including the plural wireless base stations 1 and the femto base station 10 is present, the MME 30 that manages the wireless base stations 1 and the femto base station 10 is located. In calling up the wireless communication terminal, the MME 30 transmits the paging signal to the wireless base stations 1 in the tracking area 20 in which the wireless communication terminal is present with reference to the tracking area database of the HSS 40. The information of the tracking area database in the HSS 40 is regularly updated by the MME 30. The MME 30 collects the communication logs for each wireless communication terminal from the wireless base stations 1, and the service area information on the femto base station from the femto base station 10. Then, the MME 30 updates the wireless base station prioritization table in the tracking area management device within the MME, and updates the tracking area database in the HSS 40.

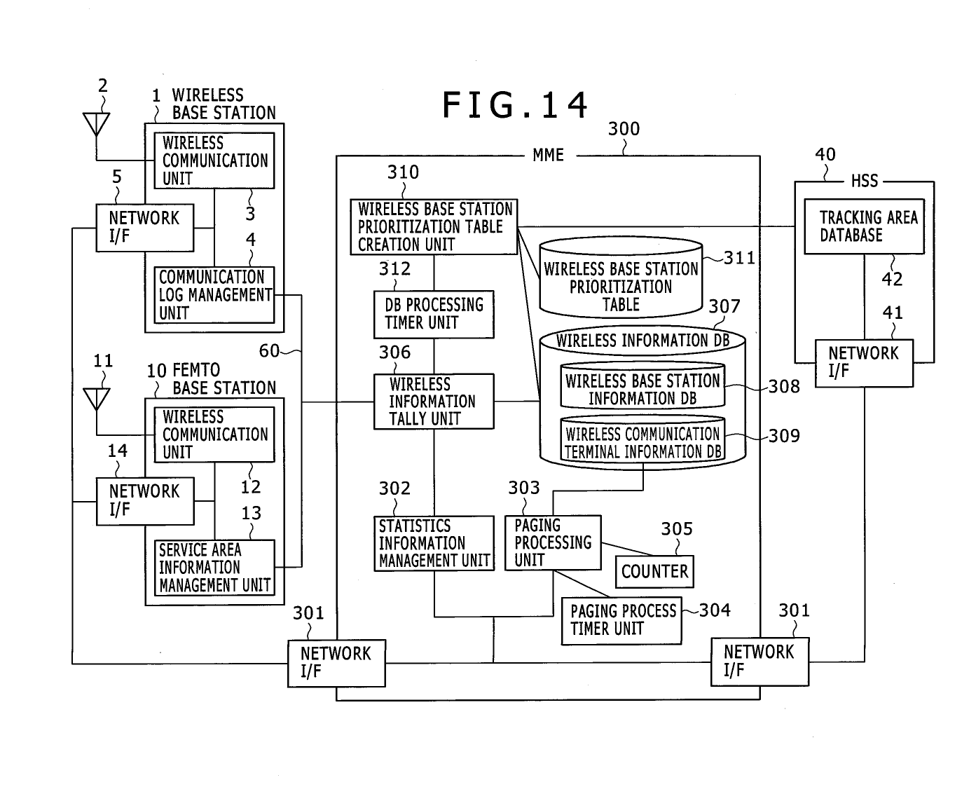

FIG. 14 is a diagram illustrating a detailed configuration of a management system according to the second embodiment. The wireless base stations 1 each include the wireless communication unit 3 that is connected to the antenna 2, the communication log management unit 4, and the network interface 5 that is connected to the MME 30. The wireless base station 1 communicates with the wireless communication terminal through the wireless communication unit 3 from the antenna 2, generates communication logs at the time of starting and ending a communication, and at the time of implementing a handover, and saves the communication logs in the communication log management unit 4. The communication logs saved in the communication log management unit 4 are transmitted to the wireless information tally unit 51 in the tracking area management device 50 through the wired network 60.

Likewise, the femto base station 10 includes the wireless communication unit 12 that is connected to the antenna 11, the service area information management unit 13, and the network interface 14 that is connected to an MME 300. The femto base station 10 communicates with the wireless communication terminal through the wireless communication unit 12 from the antenna 11, and saves information on the terminal which is present in the femto base station 10 in question in the service area information management unit 13. The information on the terminal present in the service area, which has been saved in the service area information management unit 13, is transmitted to a wireless information tally unit 306 in the MME 300 through the wired network 60. Also, the MME 300 collects statistics information for each of the wireless base stations through a network interface 301, and saves the statistics information in a statistics information management unit 302. The information collected in the statistics information management unit 302 is transmitted to the wireless information tally unit 306. The wireless information tally unit 306 which has received those pieces of information updates a wireless information database 307. Also, a wireless base station prioritization table creation unit 310 prioritizes the wireless base stations to which the paging signal is transmitted in each of the tracking areas according to the information of the wireless information database 307, and updates a wireless base station prioritization table 311. Upon updating the wireless base station prioritization table 311, the wireless base station prioritization table creation unit 310 updates base station prioritization items of the tracking area database 42 in the HSS 40. Also, the wireless base station prioritization table creation unit 310 can regularly conduct those processing with the use of a database processing timer unit 312.

During a paging process, a paging processing unit 303 accesses to a network I/F 41 of the HSS 40 through the network interface 301, determines the tracking area to which the paging signal is transmitted, and transmits the paging signal according to the prioritization within the tracking area database 42.

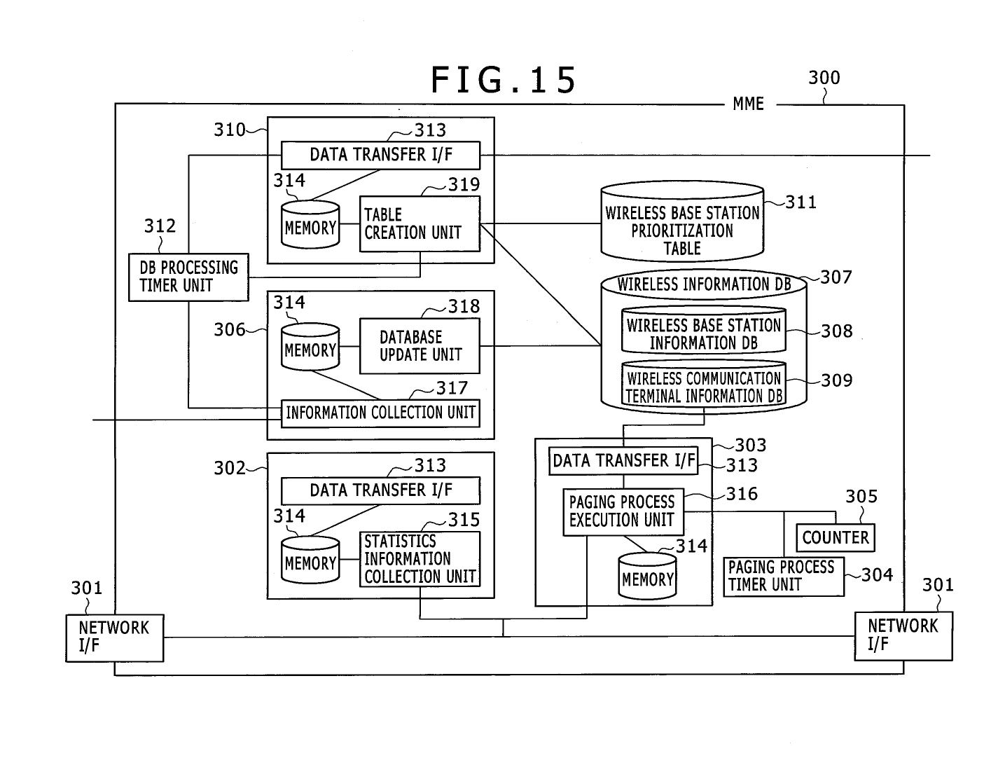

FIG. 15 is a configuration diagram of the MME 300 according to the second embodiment. The MME 300 includes the statistics information management unit 302 that collects statistics information, which is collected from the network interface 301, the paging process unit 303 that conducts the paging process on the basis of the information on the tracking area 20, which is obtained from the HSS 40 through the network interface 301, and a paging process timer unit 304 that measures a time required for the paging process. The MME 300 also includes a counter 305 that tallies the number of wireless base stations to which the paging signal has been transmitted, and the wireless information collection unit 306 that collects the information from the communication log management unit 4, the service area information management unit 13, and the statistics information management unit 32, and regularly updates the wireless information database 307. The MME 300 further includes the wireless base station prioritization table creation unit 310 that creates and updates the wireless base station prioritization table 311 with the use of the wireless information database 307, and the database processing timer unit 312 that regularly operates the wireless information tally unit 306 and the wireless base station prioritization table creation unit 310.

Also, the wireless information database 307 includes a wireless base station information database 308 that stores the information for each of the wireless base stations therein, and a wireless communication terminal information database 309 that stores the information for each wireless communication terminal therein. The statistics information management unit 302 includes a statistics information collection unit 315 that collects the statistics information, a memory 314 that stores the statistics information collected by the statistics information collection unit 315, and a data transfer interface 313 that transfers data in the memory 314 to the wireless information tally unit 306. Also, the paging processing unit 303 includes the data transfer interface 313 that collects the information from the wireless communication terminal information database 309, the memory 314 that stores the information obtained from the wireless communication terminal information database 309, and threshold values of the number of transmission and a time required for the transmission in an algorithm at the time of transmitting the paging signal, and a paging process execution unit 316 that executes the paging process. The paging process execution unit 316 executes the paging process in conjunction with the paging process timer unit 304 and the counter 305 within the MME 30.

The wireless information tally unit 306 includes an information collection unit 317 that collects the respective information, the memory 314 that stores the information collected by the information collection unit 317, and a database update unit 318 that updates the database from the information stored in the memory 314.

Also, the wireless base station prioritization table creation unit 310 includes the memory 314 that stores the information of the wireless information database 307, and the information of the prioritization table, a table creation unit 319 that creates the wireless base station prioritization management table on the basis of the information stored in the wireless information database 307, and the data transfer interface 313 that transfers those information to the tracking area database 42.

An example of various databases, a method of determining the prioritization of the wireless base stations within the tracking area, a flow of the paging process, and so on are identical with those in the first embodiment, and therefore their description will be omitted.

### Third Embodiment

Finally, a third embodiment of the present invention will be described in detail with reference to the drawings. In the third embodiment of the present invention, the wireless base station prioritization management table creation unit according to the first and second embodiments conducts prioritization through a method different from that of the first and second embodiments when prioritizing the wireless base stations. The other configurations are identical with that of the first and second embodiments, and therefore its description will be omitted.

The feature of this embodiment resides in that a paging hit ratio is calculated for each of the wireless base stations according to the number of calls and the number of transmission of the paging signal, and the prioritization table is generated on the basis of the paging hit ratio. With the use of this embodiment, the wireless base stations in which a large number of wireless communication terminals targeted for the paging signal are present can be determined, as a result of which the amount of paging signals can be reduced.

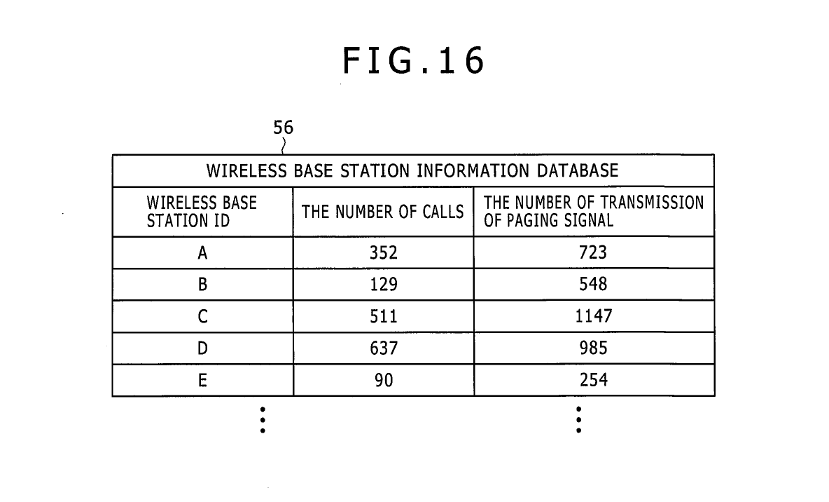

FIG. 16 illustrates an example of the wireless base station information database 56 according to the third embodiment. The MME 30 holds which wireless base station the paging signal has been transmitted to as the statistics information, and the statistics information management unit 32 holds the statistics information for each of the wireless base stations. The statistics information is transmitted to the wireless information tally unit 51, and the wireless information tally unit 51 is updated by the wireless information tally unit 51. In this example, the number of calls within a given time, and the number of transmission of the paging signal are stored for each of the wireless base station IDs therein.

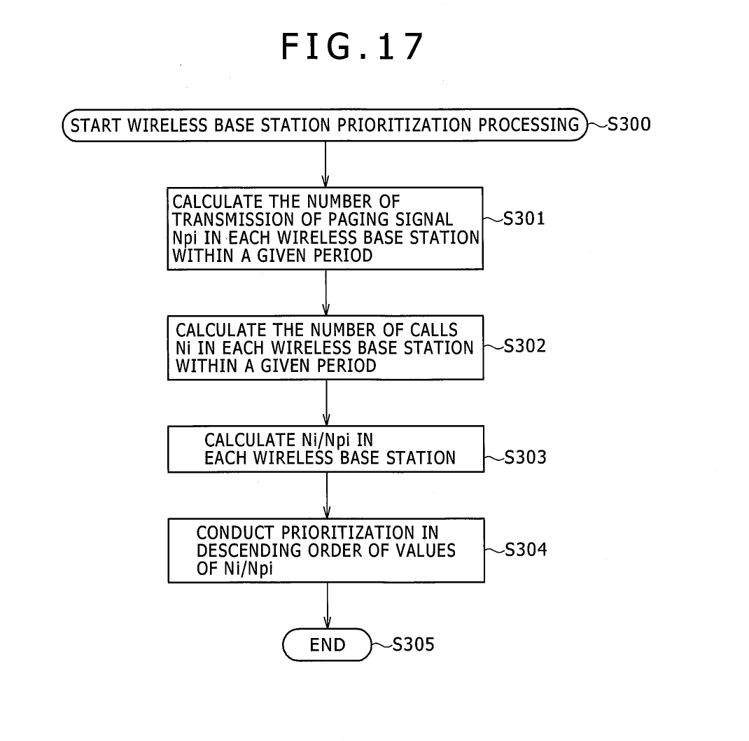

FIG. 17 is a flowchart of determining the prioritization of the wireless base stations within the tracking area according to the third embodiment. The prioritization is executed by the wireless base station prioritization table creation unit with a given time elapsed in the timer unit 55 of the tracking area management device 50 as a trigger.

In S300, the wireless base station prioritization processing starts. First, in S301, the number of transmissions NPi of the paging signal in each of the wireless base stations within a given time in the wireless base station information database 56 within the wireless information database 52 is calculated. Then, in S302, the number of calls Ni generated within a given time is calculated. In S303, Ni/NPi in each of the wireless base stations is calculated, and set as a paging bit ratio. Finally, in S304, the prioritization is conducted in a descending order of values of Ni/NPi, and in S305, the wireless base station prioritization processing is completed.

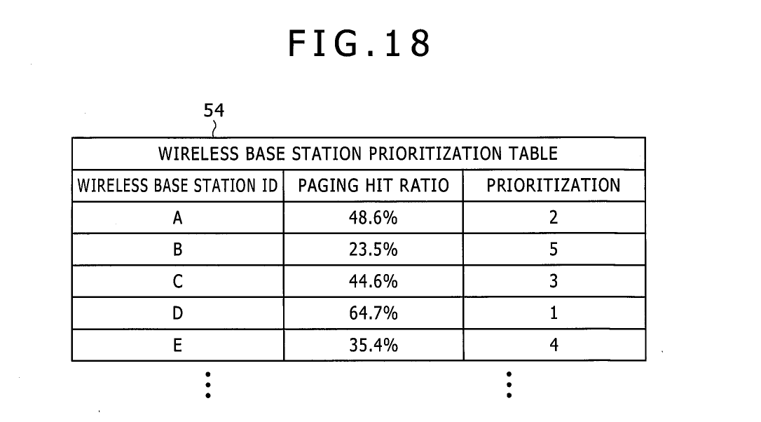

FIG. 18 illustrates an example of the wireless base station prioritization table 54 according to the third embodiment. The value of the above-mentioned paging hit ratio Ni/NPi, and the prioritization of the paging signal transmission are stored for each of the wireless base station IDs in the wireless base station prioritization table 54.

The respective embodiments of the present invention have been described above. However, the present invention includes various modified examples without departing from the subject matter of the present invention. For example, in the above-mentioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

What is claimed is:

1. A wireless communication method in a wireless communication system that transmits a paging signal to a plurality of base stations configuring a tracking area, comprising:
allowing a wireless communication terminal to communicate with each of a plurality of base stations;
generating information on a position of the wireless communication terminal on the basis of communication results between the wireless communication terminal and each of the plurality of base stations;
determining a prioritization of the plurality of base stations to which the paging signal is transmitted on the basis of the information on the position of the wireless communication terminal; and
transmitting the paging signal to the base stations on the basis of the prioritization.

2. The wireless communication method according to claim 1,
wherein the plurality of base stations includes a plurality of wireless base stations, and a femto base station, and
wherein information on a position of the wireless communication terminal includes at least one of communication logs including call disconnection histories between the wireless communication terminal and the wireless base stations, information on the wireless communication terminal that is present in a service area of the femto base station, the number of calls to the wireless base stations, the number of handovers to the wireless base stations, and the number of transmissions of the paging signal.

3. The wireless communication method according to claim 2, further comprising:
generating a prioritization table indicative of a prioritization of transmitting the paging signal to the plurality of wireless base stations on the basis of the number of calls and the number of handovers, or the number of calls and the number of transmission of the paging signal;
transmitting the paging signal to the femto base station when it is determined that the wireless communication terminal to be received is present in the service area of the femto base station, on the basis of the information of the wireless communication terminal which is present in the service area of the femto base station;
transmitting the paging signal to the wireless base station that has been finally call-disconnected on the basis of the communication logs when it is determined that the wireless communication terminal to be received is not present in the service area of the femto base station; and
transmitting the paging signal according to the prioritization table when there is no response to the paging signal, or when the wireless base station that has been finally call-disconnected is not present.

4. The wireless communication method according to claim 3, further comprising:
calculating a probability of handover from the adjacent base stations for each of the wireless base stations according to the number of calls and the number of handovers; and
generating the prioritization table on the basis of the probability of handovers from the adjacent base stations.

5. The wireless communication method according to claim 3, further comprising:
calculating a paging hit ratio for each of the wireless base stations according to the number of calls and the number of transmission of the paging signal; and
generating the prioritization table on the basis of the paging hit ratio.

6. The wireless communication method according to claim 3, further comprising:
concurrently transmitting the paging signal to the plurality of wireless base stations which are present within the tracking area, and to which the paging signal has not been transmitted when there is no response to the paging signal even if a given time elapses since a process of transmitting the paging signal to the wireless base stations starts.

7. The wireless communication method according to claim 3, further comprising:
concurrently transmitting the paging signal to the plurality of wireless base stations which are present within the tracking area, and to which the paging signal has not been transmitted when there is no response to the paging signals even if a given number of paging signals are transmitted to the wireless base stations.

8. A tracking area management device in a wireless communication system that transmits a paging signal to a plurality of base stations configuring a tracking area,
wherein the tracking area management device receives information on a position of the wireless communication terminal, which is generated on the basis of communication results between the wireless communication terminal and the plurality of base stations, and
wherein the tracking area management device determines the prioritization of the plurality of base stations to which the paging signal is transmitted, on the basis of information on the position of the wireless communication terminal.

9. The tracking area management device according to claim 8,
wherein the plurality of base stations includes a plurality of wireless base stations, and a femto base station, and
wherein information on a position of the wireless communication terminal includes at least one of communication logs including call disconnection histories between the wireless communication terminal and the wireless base stations, information on the wireless communication terminal that is present in a service area of the femto base station, the number of calls to the wireless base stations, the number of handovers to the wireless base stations, and the number of transmissions of the paging signal.

10. The tracking area management device according to claim 9,
wherein the tracking area management device generates a prioritization table on the basis of the number of calls and the number of handovers, or the number of calls and the number of transmission of the paging signal,
wherein the tracking area management device transmits the paging signal to the femto base station when the wireless communication terminal to be received is present in the service area of the femto base station,
wherein the tracking area management device transmits the paging signal to the wireless base station that has been finally call-disconnected on the basis of the communication logs when the wireless communication terminal to be received is not present in the service area of the femto base station, and
wherein the tracking area management device transmits the paging signal according to the prioritization table when there is no response to the paging signal, or when the wireless base station that has been finally call-disconnected is not present.

11. The tracking area management device according to claim 10,
wherein the tracking area management device calculates a probability of handover from the adjacent base stations for each of the wireless base stations according to the number of calls and the number of handovers, and
wherein the tracking area management device generates the prioritization table on the basis of the probability of handovers from the adjacent base stations.

12. The tracking area management device according to claim 10,
wherein the tracking area management device calculates a paging hit ratio for each of the wireless base stations according to the number of calls and the number of transmission of the paging signal, and
wherein the tracking area management device generates the prioritization table on the basis of the paging hit ratio.

13. A mobility management device that transmits a paging signal to a plurality of base stations configuring a tracking area,
wherein the mobility management device determines a prioritization of the plurality of base stations to which the paging signal is to be transmitted, on the basis of information on a position of the wireless communication terminal, which is generated on the basis of communication results between the wireless communication terminal and the plurality of base stations, and
wherein the mobility management device transmits the paging signal on the basis of the prioritization.

14. The mobility management device according to claim 13,
wherein the plurality of base stations includes a plurality of wireless base stations, and a femto base station, and
wherein information on a position of the wireless communication terminal includes at least one of communication logs including call disconnection histories between the wireless communication terminal and the wireless base stations, information on the wireless communication terminal that is present in a service area of the femto base station, the number of calls to the wireless base stations, the number of handovers to the wireless base stations, and the number of transmissions of the paging signal.

15. The mobility management device according to claim 14,
wherein the mobility management device generates a prioritization table indicative of a prioritization of the plurality of wireless base stations to which the paging signal is transmitted, on the basis of the number of calls and the number of handovers, or the number of calls and the number of transmission of the paging signal,
wherein the mobility management device transmits the paging signal to the femto base station when the wireless communication terminal to be received is present in the service area of the femto base station,
wherein the mobility management device transmits the paging signal to the wireless base station that has been finally call-disconnected on the basis of the communication logs when the wireless communication terminal to be received is not present in the service area of the femto base station, and
wherein the mobility management device transmits the paging signal according to the prioritization table when there is no response to the paging signal, or when the wireless base station that has been finally call-disconnected is not present.
